(19) United States
(12) Patent Application Publication
(10) Pub. No.: US 2019/0264011 A1
(43) Pub. Date: Aug. 29, 2019

(54) RUBBER COMPOSITION FOR TIRE TREAD AND PNEUMATIC TIRE

(71) Applicant: Toyo Tire Corporation, Itami-shi, Hyogo (JP)

(72) Inventor: Shinya Tochika, Itami-shi, Hyogo (JP)

(73) Assignee: Toyo Tire Corporation, Itami-shi, Hyogo (JP)

(21) Appl. No.: 16/344,878

(22) PCT Filed: Nov. 21, 2017
(86) PCT No.: PCT/JP2017/041836

§ 371 Date: Apr. 25, 2019

(30) Foreign Application Priority Data
Dec. 8, 2016 (JP) 2016-238836

(51) Int. Cl. C08L 9/06; C08K 3/36; C08K 3/04; C08K 11/00; B60C 1/00; B60C 11/00

(52) U.S. Cl. CPC C08L 9/06; C08K 3/36; C08K 3/04; C08K 11/00; C08L 2205/035; B60C 11/0008; C08L 2205/025; C08L 2205/03; B60C 1/0016

(57) ABSTRACT

While suppressing a decrease in low-temperature performance, performance at ambient temperature, such as wet performance and dry performance, is improved. A rubber composition for a tire tread according to an embodiment includes, per 100 parts by mass of a rubber component containing a styrene-butadiene rubber having a glass transition temperature of −60° C. or less, 70 parts by mass or more of a reinforcing filler containing silica. The rubber composition has, when vulcanized, a storage modulus E′(−20° C.) at a temperature of −20° C. and a storage modulus E′(30° C.) at a temperature of 30° C. such that the ratio between E′(−20° C.) and E′(30° C.) measured under conditions of a frequency of 10 Hz, an initial strain of 10%, and a dynamic strain of ±0.25% satisfies 2.0≤E′(−20° C.)/E′(30° C.)≤3.0.

### TECHNICAL FIELD

The present invention relates to a rubber composition for a tire tread and also to a pneumatic tire using the same.

### BACKGROUND ART

In winter tires, such as studless tires and snow tires, in order to improve low-temperature performance, such as on-ice performance and on-snow performance, the tread rubber is generally soft. Accordingly, their running performance on a wet road surface (wet performance) or running performance on a dry road surface (dry performance) at ambient temperature is not necessarily sufficient. Thus, it is required to improve performance at ambient temperature, such as wet performance and dry performance, while maintaining low-temperature performance.

For the purpose of providing a high-performance tire having excellent low-temperature performance and also excellent wet performance, PTL 1 discloses a rubber composition including a rubber component containing a styrene-butadiene rubber having a styrene content of 30 to 38% blended with carbon black having a nitrogen specific surface area of 80 cm²/g or more and a neopentyl-type polyol ester, the rubber composition having a tan δ at 0° C. of 0.74 or more and a storage modulus at −20° C. of 30 MPa or less.

For the purpose of providing a high-kinetic-performance tire having all-weather performance capable of easily running on an icy/snowy road surface, PTL 2 discloses a rubber composition including a rubber component containing a diene-based rubber having a glass transition temperature of −65° C. or less and a diene-based rubber having a glass transition temperature of −55° C. or more blended with carbon black having a nitrogen absorption of 125 to 145 m²/g and an ester-based low-temperature softener, the rubber composition having an elastic modulus at 100% elongation at −20° C. of 40 kg/cm² or less and a tan δ at 30° C. of 0.3 or more.

For the purpose of providing a tire that exhibits high steering stability on a wet road surface and a dry road surface from low temperature to high temperature, PTL 3 discloses a rubber component containing an emulsion-polymerized styrene-butadiene rubber and a solution-polymerized styrene-butadiene rubber blended with a filler containing 20 to 80% silica and a softener, wherein the ratio of the storage modulus at 30° C. to the storage modulus at 100° C. is 0.43 or more, and the hysteresis loss at 150% strain is 0.3 or more.

However, they are not necessarily sufficient for improving performance at ambient temperature while maintaining low-temperature performance, and further improvement is required.

### CITATION LIST

### Patent Literature

PTL 1: JP-B-H6-25280

PTL 2: JP-B-H4-70340

PTL 3: JP-A-H8-333484

### SUMMARY OF INVENTION

### Technical Problem

An object of an embodiment of the invention is to provide a rubber composition for a tire tread, which is capable of improving performance at ambient temperature, such as wet performance and dry performance, while suppressing a decrease in low-temperature performance.

### Solution to Problem

A rubber composition for a tire tread according to this embodiment includes, per 100 parts by mass of a rubber component containing a styrene-butadiene rubber having a glass transition temperature of −60° C. or less, 70 parts by mass or more of a reinforcing filler containing silica. The rubber composition has, when vulcanized, a storage modulus E′(−20° C.) at a temperature of −20° C. and a storage modulus E′(30° C.) at a temperature of 30° C. such that the ratio between E′(−20° C.) and E′(30° C.) measured under conditions of a frequency of 10 Hz, an initial strain of 10%, and a dynamic strain of ±0.25% satisfies 2.0≤E′(−20° C.)/E′(30° C.)≤3.0.

A pneumatic tire according to this embodiment includes a tread rubber including the rubber composition.

### Advantageous Effects of Invention

According to this embodiment, together with a rubber component containing a styrene-butadiene rubber having a glass transition temperature of −60° C. or less, a reinforcing filler containing silica is blended. Also, changes in storage modulus from low temperature to ambient temperature are set small. As a result, it is possible to improve performance at ambient temperature, such as wet performance and dry performance, while suppressing a decrease in low-temperature performance.

DESCRIPTION OF EMBODIMENTS

Hereinafter, matters relevant to the practice of the invention will be described in detail.

In a rubber composition according to this embodiment, the rubber component contains a styrene-butadiene rubber (SBR) having a glass transition temperature (Tg) of −60° C. or less. A styrene-butadiene rubber has a non-unitary structure and thus can suppress crystallization. Further, by using a styrene-butadiene rubber having a low glass transition temperature, the storage modulus at low temperature can be effectively reduced, thereby improving low-temperature performance. In addition, this is also advantageous in reducing changes in storage modulus from low temperature to ambient temperature.

The styrene-butadiene rubber is not particularly limited, but is preferably a solution-polymerized styrene-butadiene rubber. As one embodiment, the glass transition temperature of the styrene-butadiene rubber may be −65° C. or less. The lower limit of the glass transition temperature is not particularly set, but is usually −80° C. or more. Here, the glass transition temperature is a value measured in accordance with JIS K7121 by a differential scanning calorimetry (DSC) method at a temperature rise rate of 20° C./min (measurement temperature range: −150° C. to 50° C.).

The rubber component may be composed only of the styrene-butadiene rubber having a glass transition temperature of −60° C. or less, but it is also possible to use the styrene-butadiene rubber with, for example, at least one of other diene rubbers such as a natural rubber (NR), an isoprene rubber (IR), a polybutadiene rubber (BR), a styrene-isoprene rubber, a butadiene-isoprene rubber, and a styrene-butadiene-isoprene rubber.

According to one preferred embodiment, the rubber component is composed of (A) a styrene-butadiene rubber having a glass transition temperature of −60° C. or less and (B) another diene rubber having a glass transition temperature of −60° C. or less, and more preferably composed only of (A) and (B). Like this, when the glass transition temperature of the entire rubber component is −60° C. or less, and also the above styrene-butadiene rubber is contained, this is advantageous in reducing changes in storage modulus from low temperature to ambient temperature, thereby improving low-temperature performance.

In one embodiment, it is preferable that the rubber component contains, together with the styrene-butadiene rubber having a glass transition temperature of −60° C. or less, a natural rubber and a polybutadiene rubber. When these three components are used, low-temperature performance can be improved while ensuring abrasion resistance. More specifically, it is preferable that 100 parts by mass of the rubber component contains 15 to 50 parts by mass of the styrene-butadiene rubber having a glass transition temperature of −60° C. or less, 15 to 50 parts by mass of a natural rubber, and 15 to 45 parts by mass of a polybutadiene rubber. It is more preferable that 100 parts by mass of the rubber component contains 30 to 45 parts by mass of the styrene-butadiene rubber having a glass transition temperature of −60° C. or less, 20 to 35 parts by mass of a natural rubber, and 25 to 40 parts by mass of a polybutadiene rubber.

In the rubber composition according to this embodiment, silica is blended as a reinforcing filler (i.e., filler). When a reinforcing filler containing silica is blended in an amount of 70 parts by mass or more per 100 parts by mass of the rubber component, rigidity at ambient temperature can be improved, thereby improving wet performance and dry performance. The upper limit of the amount of reinforcing filler blended is not particularly set, and may be 120 parts by mass or less, for example, or may also be 100 parts by mass or less.

As silica, for example, it is preferable to use wet silica, such as wet-precipitated silica or wet-gelled silica. The BET specific surface area of silica (measured in accordance with the BET Method specified in JIS K6430) is not particularly limited, and may be 90 to 250 m²/g, for example, or may also be 150 to 220 m²/g. The amount of silica blended may be 20 to 70 parts by mass, or may also be 30 to 50 mass, per 100 parts by mass of the rubber component. Increasing the amount of silica blended is advantageous in reducing the storage modulus at low temperature.

The reinforcing filler may be silica alone, and may also be a combination of silica and carbon black. In this case, the amount of carbon black blended is not particularly limited, and may be 10 to 60 parts by mass, 20 to 60 parts by mass, or 30 to 50 parts by mass per 100 parts by mass of the rubber component. Carbon black is not particularly limited, and it is preferable to use one having a nitrogen adsorption specific surface area (N₂SA) (JIS K6217-2) of 30 to 130 m²/g, for example. Specifically, ISAF grade (N 200s), HAF grade (N 300s), FEF grade (N 500s), and GPF grade (N 600s) (all ASTM grades) can be mentioned. It is more preferable that the N₂SA is 70 to 130 m²/g.

A silane coupling agent, such as sulfide silane or mercapto silane, may also be blended into the rubber composition according to this embodiment. When a silane coupling agent is blended, abrasion resistance and rolling resistance performance can be improved. The amount of silane coupling agent blended is not particularly limited, but is preferably 2 to 20 mass % of the amount of silica blended (i.e., the silane coupling agent is 2 to 20 parts by mass per 100 parts by mass of silica), and more preferably 5 to 15 mass %.

A resin may be blended into the rubber composition according to this embodiment. As the resin, it is preferable to use a resin with adhesiveness having a softening point is 80 to 120° C., that is, an adhesive resin, for example. When a resin is blended, wet performance and dry performance can be improved. Here, the softening point is a value measured by the Ring-and-Ball Method in accordance with JIS K2207.

Examples of resins include rosin-based resins, petroleum resins, coumarone-based resins, and terpene-based resins. They may be used alone, and it is also possible to use two or more kinds together. Examples of rosin-based resins include a natural rosin resin and various types of rosin-modified resins using the same (e.g., rosin-modified maleic acid resin). Examples of petroleum resins include aliphatic petroleum resins (C5 petroleum resins), aromatic petroleum resins (C9 petroleum resins), and aliphatic/aromatic copolymer petroleum resins (C5/C9 petroleum resins). Examples of coumarone-based resins include a cumarone resin, a coumarone-indene resin, and copolymer resins containing coumarone, indene, and styrene as main components. Examples of terpene-based resins include polyterpene and a terpene-phenol resin.

The content of the resin is not particularly limited, and may be 0.5 to 20 parts by mass, 1 to 10 parts by mass, or 2 to 5 parts by mass per 100 parts by mass of the rubber component, for example.

In the rubber composition according to this embodiment, at least one antiskid material selected from the group consisting of a vegetable granular material and a ground product of a porous carbonized material of a plant may be blended. When an antiskid material is blended, on-ice performance can be improved.

As a vegetable granular material, a ground product obtained by grinding at least one member selected from the group consisting of seed husks, fruit pits, grains, and cores thereof can be mentioned. Examples thereof include a ground product of walnuts. The ground product of the porous carbonized material is a product obtained by grinding a porous material formed of a carbon-based solid product obtained by carbonizing a plant such as wood or bamboo as a material. Examples thereof include a ground product of bamboo charcoal (bamboo charcoal ground product). The average particle size of the antiskid material is not particularly limited. For example, the 90% volume particle size (D90) may be 10 to 600 μm. Here, D90 means the particle size at an integrated value of 90% in the particle size distribution (volume basis) measured by a laser diffraction/scattering method.

The content of the antiskid material is not particularly limited, and may be 0.1 to 10 parts by mass, or may also be 0.2 to 5 parts by mass, per 100 parts by mass of the rubber component, for example.

An oil may be blended into the rubber composition according to this embodiment. As the oil, any of various oils commonly blended into a rubber composition can be used. For example, a mineral oil containing a hydrocarbon as a main component, that is, at least one mineral oil selected from the group consisting of paraffinic oils, naphthenic oils, and aromatic oils, may be used. The content of the oil is not particularly limited, and may be 10 to 60 parts by mass, or may also be 20 to 50 parts by mass, per 100 parts by mass of the rubber component, for example.

In the rubber composition according to this embodiment, in addition to the components described above, various additives commonly used in a rubber composition, such as stearic acid, zinc oxide, antioxidants, waxes, vulcanizers, and vulcanization accelerators, may be blended. Examples of vulcanizers include sulfur such as powder sulfur, precipitated sulfur, colloidal sulfur, insoluble sulfur, and highly dispersed sulfur. The amount of vulcanizer blended is preferably, but not particularly limited to, 0.1 to 8 parts by mass, more preferably 0.5 to 5 parts by mass, per 100 parts by mass of the rubber component.

The rubber composition according to this embodiment has, when vulcanized, a storage modulus E′(−20° C.) at a temperature of −20° C. and a storage modulus E′(30° C.) at a temperature of 30° C. such that the ratio between E′(−20° C.) and E′(30° C.) measured under conditions of a frequency of 10 Hz, an initial strain of 10%, and a dynamic strain of ±0.25%, that is, the ratio of E′(−20° C.) to E′(30° C.), satisfies 2.0≤E′(−20° C.)/E′(30° C.) 3.0. Like this, when changes in storage modulus E′ from low temperature to ambient temperature are reduced, low-temperature performance and performance at ambient temperature, such as dry performance and wet performance, are compatible.

Specifically, when considered based on performance at ambient temperature, because an increase in elastic modulus at low temperature (hardening) is small, a decrease in low-temperature performance can be suppressed. In addition, when considered based on low-temperature performance, because a decrease in elastic modulus at ambient temperature (softening) is small, a decrease in dry performance and wet performance at ambient temperature can be suppressed.

The ratio E′(−20° C.)/E′(30° C.) is preferably 2.2 or more, more preferably 2.4 or more, and is preferably 2.9 or less, more preferably 2.7 or less.

The rubber composition according to this embodiment can be prepared by kneading in the usual manner using a mixer that is usually used, such as a Banbury mixer, a kneader, or a roll. That is, in the first mixing stage, a reinforcing filler and also other additives excluding a vulcanizer and a vulcanization accelerator are added to a rubber component and mixed, and subsequently, in the final mixing stage, a vulcanizer and a vulcanization accelerator are added to the obtained mixture and mixed, whereby the rubber composition can be prepared.

The rubber composition thus obtained is used for a tread rubber that forms the tread of a pneumatic tire. The rubber composition is preferably used for a tread rubber of a winter tire, such as a studless tire or a snow tire. Incidentally, the tread rubber of a pneumatic tire has a two-layer structure including a cap rubber and a base rubber or a monolayer structure in which the two are integrated, and the rubber composition is preferably used for a rubber forming the tread. That is, in the case of a monolayer structure, it is preferable that the tread rubber includes the above rubber composition, while in the case of a two-layer structure, it is preferable that the cap rubber includes the above rubber composition.

The method for producing a pneumatic tire is not particularly limited. For example, the rubber composition is formed into a predetermined shape by extrusion in the usual manner to prepare an unvulcanized tread rubber member. The tread rubber member is combined with other members to prepare an unvulcanized tire (green tire), followed by vulcanization molding at 140 to 180° C., for example. As a result, a pneumatic tire can be produced.

### EXAMPLES

Hereinafter, examples of the invention will be shown, but the invention is not limited to these examples.

Using a Banbury mixer, following the formulation (part by mass) shown in Tables 1 and 2 below, first, in the first mixing stage, agents to be blended excluding sulfur and a vulcanization accelerator were added to a rubber component and kneaded (discharge temperature=160° C.), and subsequently, in the final mixing stage, sulfur and a vulcanization accelerator were added to the obtained mixture and kneaded (discharge temperature=90° C.), thereby preparing a rubber composition. The details of the components in Tables 1 and 2 are as follows.

NR: RSS#3 (Tg: −60° C.)

BR: “BR150B” manufactured by Ube Industries, Ltd. (Tg: −100° C.)

SBR1: Solution-polymerized SBR, “TUFDENE 1834” manufactured by Asahi Kasei Corporation (Tg: −70° C., 37.5 parts by mass oil-extended product)

SBR2: Solution-polymerized SBR, “TUFDENE 4850” manufactured by Asahi Kasei Corporation (Tg: −25° C., 50.0 parts by mass oil-extended product)

SBR3: Solution-polymerized SBR (Tg: −60° C., styrene content: 25 mass %, vinyl content: 13 mass %, 37.5 parts by mass oil-extended product)

Carbon black: “SEAST KH (N339)” manufactured by Tokai Carbon Co., Ltd. (N₂SA: 93 m²/g)

Silica: “Nipsil AQ” manufactured by Tosoh Silica Corporation (BET: 205 m²/g)

Oil: Paraffinic, “PROCESS P200” manufactured by JX Nippon Oil & Energy Corporation

Silane coupling agent: Sulfide silane, “Si75” manufactured by Evonik

Vegetable granular material: Walnut husk ground product (“SOFT GRIT #46” manufactured by Nippon Walnut Co., Ltd.) surface-treated with an RFL treatment liquid (D90: 300 μm)

Rosin-based resin: Rosin-modified maleic acid resin, “HARIMACK R100” manufactured by Harima Chemicals Group, Inc. (softening point: 100 to 110° C.)

Stearic acid: “LUNAC S−20” manufactured by Kao Corporation

Zinc oxide: “Zinc Oxide No. 1” manufactured by Mitsui Mining & Smelting Co., Ltd.

Wax: “OZOACE 0355” manufactured by Nippon Seiro Co., Ltd.

Antioxidant: “Nocrac 6C” manufactured by Ouchi Shinko Chemical Industrial Co., Ltd.

Vulcanization accelerator: “Nocceler D” manufactured by Ouchi Shinko Chemical Industrial Co., Ltd.

Sulfur: “Powder Sulfur” manufactured by Tsurumi Chemical Industry Co., Ltd.

Using a test piece obtained by vulcanizing each rubber composition at 160° C. for 30 minutes, the storage modulus E′(MPa) at −20° C. and that at 30° C. were measured, and the ratio between the two, E′(−20° C.)/E′(30° C.), was determined for each rubber composition. In addition, each rubber composition was used for a tread rubber and subjected to vulcanization molding in the usual manner, thereby preparing a pneumatic tire (tire size: 195/65R15). The abrasion resistance, on-ice performance, wet performance, and dry performance of the obtained tire were evaluated. The measurement/evaluation methods are as follows.

E′: In accordance with JIS K6394, using a viscoelasticity tester manufactured by Toyo Seiki Seisaku-sho, Ltd., E′(−20° C.) was measured under conditions of a frequency of 10 Hz, an initial strain of 10%, a dynamic strain of ±0.25%, and a temperature of −20° C. (elongation deformation). The test piece was strip-shaped having a width of 5 mm and a thickness of 2 mm with a pinch distance of 20 mm. In addition, E′(30° C.) was measured under the same conditions except for that the temperature was changed to 30° C.

Abrasion Resistance: Four test tires were mounted on a passenger car and run 10,000 km on a general dry road while performing right-left rotation every 2,500 km. The average depth of the remaining tread grooves of the four tires after running was expressed as an index taking Comparative Example 1 as 100. A larger value indicates better abrasion resistance.

On-Ice Performance: Four test tires were mounted on a 2,000 cc 4WD vehicle, run on an icy road (temperature: −3±3° C.) at 40 km/h, and then ABS-controlled, and the braking distance at this time was measured (average of n=10). The reciprocal of braking distance was expressed as an index taking the value of Comparative Example 1 as 100. A larger index indicates a shorter braking distance and better braking performance on an icy road surface.

Wet Performance: Four test tires were mounted on a 2,000 cc 4WD vehicle and run on a road watered to a depth of 2 to 3 mm. The vehicle was run at 90 km/h, and then, under ABS control, slowed down to 20 km/h, and the braking distance at this time was measured (average of n=10). The reciprocal of braking distance was expressed as an index taking the value of Comparative Example 1 as 100. A larger index indicates a shorter braking distance, that is, better wet performance.

Dry Performance: Four test tires were mounted on a 2,000 cc 4WD vehicle and operated by a test driver on a dry road to perform the sensory (feeling) evaluation of steering stability. The stability was evaluated on a ten-point scale, where Comparative Example 1 scores 5 points. A larger value indicates better dry performance.

TABLE 1

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Formulation (part by mass) | | | | | | | |
| NR | 50 | 50 | 50 | 50 | 30 | 50 | 10 |
| BR | 50 | 50 | 50 | 35 | 70 | 35 | 20 |
| SBR1 | — | — | — | 21 | — | — | 96 |
| | | | | (15) | | | (70) |
| SBR2 | — | — | — | — | — | 23 | — |
| | | | | | | (15) | |
| SBR3 | — | — | — | — | — | — | — |
| Carbon black | 50 | 50 | 40 | 50 | 50 | 50 | 40 |
| Silica | 5 | 15 | 35 | 5 | 5 | 5 | 35 |
| Oil | 20 | 30 | 35 | 14 | 20 | 12 | 9 |
| Silane coupling agent | — | 1.2 | 2.8 | — | — | — | 2.8 |
| Vegetable granular material | 0.2 | 0.2 | 0.2 | 0.2 | 0.2 | 0.2 | 0.2 |
| Rosin-based resin | — | — | — | — | — | — | 3 |
| Stearic acid | 2 | 2 | 2 | 2 | 2 | 2 | 2 |
| Zinc oxide | 2 | 2 | 2 | 2 | 2 | 2 | 2 |
| Wax | 2 | 2 | 2 | 2 | 2 | 2 | 2 |
| Antioxidant | 2 | 2 | 2 | 2 | 2 | 2 | 2 |
| Vulcanization accelerator | 1.5 | 1.5 | 1.5 | 1.5 | 1.5 | 1.5 | 1.5 |
| Sulfur | 2 | 2 | 2 | 2 | 2 | 2 | 2 |
| Physical Properties/Evaluation | | | | | | | |
| E′(−20° C.)/E′(30° C.) | 3.5 | 3.6 | 3.2 | 3.4 | 1.9 | 3.8 | 3.2 |
| Abrasion resistance | 100 | 99 | 98 | 96 | 109 | 92 | 95 |
| On-ice performance | 100 | 95 | 97 | 102 | 106 | 90 | 95 |
| Wet performance | 100 | 102 | 103 | 95 | 90 | 106 | 102 |
| Dry performance | 5 | 5 | 6 | 6 | 4 | 7 | 6 |

* Numbers in parenthesis for SBR1 to SBR3 each show the amount of rubber content.

TABLE 2

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| Formulation (part by mass) | | | | | | | | | |
| NR | 50 | 50 | 25 | 15 | 50 | 50 | 40 | 50 | 50 |
| BR | 35 | 35 | 35 | 35 | 35 | 15 | 45 | 35 | 35 |
| SBR1 | 21 | 21 | 55 | 69 | 48 | 21 | 21 | 21 | 21 |
| | (15) | (15) | (40) | (50) | — | (35) | (15) | (15) | (15) |
| SBR2 | — | — | — | — | — | — | — | — | — |
| SBR3 | — | — | — | — | 21 | — | — | — | — |
| | | | | | (15) | | | | |
| Carbon black | 40 | 40 | 40 | 40 | 40 | 40 | 40 | 45 | 40 |
| Silica | 35 | 35 | 35 | 35 | 35 | 35 | 35 | 25 | 50 |
| Oil | 29 | 29 | 20 | 16 | 29 | 22 | 29 | 24 | 39 |
| Silane coupling agent | 2.8 | 2.8 | 2.8 | 2.8 | 2.8 | 2.8 | 2.8 | 2.0 | 4.0 |
| Vegetable granular material | 0.2 | 0.2 | 0.2 | 0.2 | 0.2 | 0.2 | 0.2 | 0.2 | 0.2 |
| Rosin-based resin | — | 3 | 3 | 3 | — | — | — | — | — |
| Stearic acid | 2 | 2 | 2 | 2 | 2 | 2 | 2 | 2 | 2 |
| Zinc oxide | 2 | 2 | 2 | 2 | 2 | 2 | 2 | 2 | 2 |
| Wax | 2 | 2 | 2 | 2 | 2 | 2 | 2 | 2 | 2 |
| Antioxidant | 2 | 2 | 2 | 2 | 2 | 2 | 2 | 2 | |
| Vulcanization accelerator | 1.5 | 1.5 | 1.5 | 1.5 | 1.5 | 1.5 | 1.5 | 1.5 | 1.5 |
| Sulfur | 2 | 2 | 2 | 2 | 2 | 2 | 2 | 2 | 2 |
| Physical Properties/Evaluation | | | | | | | | | |
| E′(−20° C.)/E′(30° C.) | 2.8 | 2.9 | 2.5 | 2.3 | 2.9 | 2.9 | 2.6 | 2.8 | 2.9 |
| Abrasion resistance | 98 | 98 | 99 | 98 | 97 | 97 | 103 | 100 | 98 |
| On-ice performance | 100 | 100 | 105 | 105 | 99 | 98 | 103 | 101 | 99 |
| Wet performance | 101 | 103 | 105 | 102 | 104 | 105 | 97 | 98 | 103 |
| Dry performance | 7 | 7 | 8 | 7 | 7 | 7 | 7 | 7 | 8 |

* Numbers in parenthesis for SBR1 to SBR3 each show the amount of rubber content.

The results are shown in Tables 1 and 2. As compared with Comparative Example 1 (control) formulated to have excellent on-ice performance, in Comparative Example 2, because the amount of silica was increased, the wet performance improved, but the on-ice performance decreased. In Comparative Example 3, where the amount of silica was further increased, and the amount of carbon black was decreased, there was a tendency that the performance at ambient temperature, such as wet performance and dry performance, improved, but the results were insufficient in terms of compatibility with the on-ice performance.

In Comparative Example 4, because low-Tg SBR1 was blended, the on-ice performance improved as compared with Comparative Example 1, but the wet performance decreased. In Comparative Example 6, where high-Tg SBR2 was blended, the wet performance and the dry performance improved, but the on-ice performance and the abrasion resistance significantly deteriorated. In Comparative Example 7, where low-Tg SBR1 was used as a main component of the rubber component, and also the amount of silica was increased, there was a tendency that the wet performance and the dry performance improved, but the on-ice performance and the abrasion resistance deteriorated.

In addition, in all these Comparative Examples 1 to 4, 6, and 7, the ratio E′(−20° C.)/E′(30° C.) was more than 3.0, and the on-ice performance was not compatible with the dry performance and the wet performance.

Meanwhile, in Comparative Example 5, the amount of BR blended was increased to lower the Tg of the rubber component, whereby the on-ice performance improved. However, the wet performance and the dry performance deteriorated. In addition, the ratio E′(−20° C.)/E′(30° C.) was too low, and the low-temperature performance and the performance at ambient temperature were not compatible.

In contrast, in Examples 1 to 9, because low-Tg SBR1 or SBR3 was used in the rubber component, and also a reinforcing filler containing silica was appropriately blended, the ratio E′(−20° C.)/E′(30° C.) was within a range of 2.0 to 3.0. Accordingly, as compared with Comparative Example 1, it was possible to improve the performance at ambient temperature, such as wet performance and dry performance, while suppressing a decrease in the on-ice performance. In addition, the abrasion resistance was also substantially maintained. In particular, in Examples 3 and 4, the on-ice performance further improved as compared with Comparative Example 1 having excellent on-ice performance.

The comparison in Examples 2 to 4 shows that with an increase in the amount of low-Tg SBR, changes in storage modulus from low temperature to ambient temperature are reduced. Accordingly, presumably, due to the crystallization suppressing effect caused by mixing SBR, changes in storage modulus from low temperature to ambient temperature are reduced. In addition, the comparison between Comparative Example 4 and Example 1 shows that by increasing the amount of reinforcing filler containing silica, changes in storage modulus from low temperature to ambient temperature can be reduced.

Some embodiments of the invention have been described above. However, these embodiments are presented as examples and not intended to limit the scope of the invention. These embodiments can be practiced in other various modes, and, without departing from the gist of the invention, various omissions, substitutions, and changes can be made thereto. These embodiments, as well as omissions, substitutions, and changes thereto, for example, fall within the scope and gist of the invention, and also fall within the scope of the claimed invention and its equivalents.

1. A rubber composition for a tire tread, comprising, per 100 parts by mass of a rubber component containing a styrene-butadiene rubber having a glass transition temperature of −60° C. or less, 70 parts by mass or more of a reinforcing filler containing silica,
the rubber composition having, when vulcanized, a storage modulus E′(−20° C.) at a temperature of −20° C. and a storage modulus E′(30° C.) at a temperature of 30° C. such that the ratio between E′(−20° C.) and E′(30° C.) measured under conditions of a frequency of 10 Hz, an initial strain of 10%, and a dynamic strain of ±0.25% satisfies 2.0≤E′(−20° C.)/E′(30° C.)≤3.0.

2. The rubber composition for a tire tread according to claim 1, wherein the rubber component further contains a natural rubber and a polybutadiene rubber.

3. The rubber composition for a tire tread according to claim 1, wherein 100 parts by mass of the rubber component contains 15 to 50 parts by mass of the styrene-butadiene rubber having a glass transition temperature of −60° C. or less, 15 to 50 parts by mass of a natural rubber, and 15 to 45 parts by mass of a polybutadiene rubber.

4. The rubber composition for a tire tread according to claim 1, further comprising a resin.

5. The rubber composition for a tire tread according to claim 4, wherein the resin is an adhesive resin having a softening point of 80 to 120° C.

6. The rubber composition for a tire tread according to claim 4, wherein the resin is at least one selected from the group consisting of rosin-based resins, petroleum resins, coumarone-based resins, and terpene-based resins.

7. The rubber composition for a tire tread according to claim 1, wherein the reinforcing filler contains silica and carbon black, and the content of silica is 20 to 70 parts by mass per 100 parts by mass of the rubber component, while the content of carbon black is 10 to 60 parts by mass per 100 parts by mass of the rubber component.

8. The rubber composition for a tire tread according to claim 1, further comprising at least one antiskid material selected from the group consisting of a vegetable granular material and a ground product of a porous carbonized material of a plant.

9. The rubber composition for a tire tread according to claim 1, further comprising 10 to 60 parts by mass of an oil per 100 parts by mass of the rubber component.

10. A pneumatic tire comprising a tread rubber including the rubber composition according to claim 1.
